(19) United States
(12) Patent Application Publication
(10) Pub. No.: US 2007/0018563 A1
(43) Pub. Date: Jan. 25, 2007

(54) Self-luminous flat-panel display

(76) Inventors: Makoto Okai, Tokorozawa (JP); Tetsuya Yamazaki, Fujisawa (JP); Susumu Sasaki, Chiba (JP); Takahiko Muneyoshi, Musashimurayama (JP); Tomio Yaguchi, Sagamihara (JP); Jun Ishikawa, Mobara (JP); Nobuaki Hayashi, Kunitachi (JP)

Correspondence Address: MILBANK, TWEED, HADLEY & MCCLOY, 1 CHASE MANHATTAN PLAZA, NEW YORK, NY, 10005-1413, US

(21) Appl. No.: 11/440,335

(22) Filed: May 24, 2006

(30) Foreign Application Priority Data
May 27, 2005 (JP) 2005-155031

(51) Int. Cl. H01J 63/04; H01J 1/62

(52) U.S. Cl. 313/496

(57) ABSTRACT

This invention relates to a field-emission-type flat-panel display apparatus that obtains an image by causing the electrons emitted from each of electron sources arranged in matrix form to impinge upon the phosphors formed on a phosphor screen. A carbon nanotube is used as an electron source material in this flat-panel display apparatus, and the electron sources are formed by printing. The vertical sizes of the depressions and projections on the surface of each electron source which has been formed by printing are suppressed to a value equal to or less than 1 μm, preferably, equal to or less than 0.5 μm. This makes it possible to obtain a flat-panel display apparatus of stable emission characteristics.

### CLAIM OF PRIORITY

The present application claims priority from Japanese Application JP2005-155031 filed on May 27, 2005, the content of which is hereby incorporated by reference into this application.

### FIELD OF THE INVENTION

The present invention relates generally to display apparatuses that use electron emission into a vacuum. More particularly, the invention relates to a self-luminous flat-panel display apparatus that includes: a rear panel equipped with cathodes each having an electron source constructed of a nanomaterial, and with gate electrodes each controlling the quantity of electron emission from the electron source; and a front panel equipped with multicolored phosphor layers each emitting light by means of excitation of the electrons acquired from the rear panel, and with anodes.

### BACKGROUND OF THE INVENTION

Color cathode-ray tubes have long been commonly used in display apparatuses excellent in both brightness and resolution. However, the tendency towards image quality enhancement of information-processing apparatuses and television broadcasts in recent years is increasing a need of the flat-panel display apparatuses that are higher in both brightness and resolution, more lightweight, and require less space.

Liquid-crystal display apparatuses, plasma display apparatuses, and the like are already placed in practical use as typical examples of those flat-panel display apparatuses. In particular, the electron-emissive display apparatuses that use electron emission from an electron source into a vacuum, the organic electroluminescent (EL) display apparatuses that feature low electric power consumption, and various other types of panel display apparatuses are also approaching commercialization as products capable of being enhanced in brightness. The plasma display apparatuses, electron-emissive display apparatuses, or organic EL display apparatuses that do not require an auxiliary illumination light source are termed “self-luminous flat-panel display apparatuses.”

Among these flat-panel display apparatuses, the above-mentioned electron-emissive display apparatuses include several known types of display apparatuses. Examples include a type having the cone-shaped electron emission structure devised by C. A. Spindt et al., a type with a metal-insulator-metal (MIM) type of electron emission structure, a type with the electron emission structure (also called “surface-conductive electron source) that uses an electron emission phenomenon based on a quantum-theoretical tunneling effect, and a type that uses the electron emission phenomenon exhibited by a diamond film, a graphite film, or a nanotube such as a carbon nanotube.

The electron-emissive type of display apparatus that is one example of a self-luminous flat-panel display apparatus includes: a rear panel with an inner surface formed with an electron-emissive electron source and with a gate electrode serving as a control electrode, and a front panel having a multicolored phosphor layer and an anode on an inner surface opposed to the rear panel, both the rear and front panels being sealed with a sealing frame interposed between their respective inner peripheral edges; wherein the inside formed of up the rear panel, the front panel, and the sealing frames is maintained in a vacuum condition.

The rear panel includes a plurality of cathodes extending in a first direction on a rear substrate which uses, for example, glass or ceramics as its favorable material, arrayed next to one another in a second direction intersecting with the first direction, and each equipped with an electron source, and gate electrodes extending in the second direction and arrayed next to one another in the first direction. The quantity of electron emission from the electron source is controlled according to particular differences in potential between the cathodes and the gate electrodes (the control includes emission on/off).

Also, the front panel has a phosphor layer and an anode on a front substrate formed of a light-transmitting material such as glass. The sealing frame is attached to the respective inner peripheral edges of the rear and front panels by a bonding material such as frit glass. The degree of vacuum of the inside formed of up the rear panel, the front panel and the sealing frame is, for example, from about 10⁻⁵ to about 10⁻⁷ Torr. For a display apparatus of a large display screen size, the rear panel and the front panel are fixed together using a clearance hold member (also termed a spacer or a separator) inserted between the panels, thereby to maintain a desired clearance between both substrates.

Conventional techniques on the self-luminous flat-panel display apparatuses in which the carbon nanotube, a typical example of a nanotube, is used as an electron source material, are reported in a number of documents such as Applied Physics Letters, vol. 80 (21), pp. 4045-4047 (2002).

### SUMMARY OF THE INVENTION

In the self-luminous flat-panel display apparatuses using the carbon nanotube as an electron source material, the density of an emission point must be increased to or above a fixed value to implement visually uniform emission of light. To achieve this purpose, it is necessary to uniformize the height of the carbon nanotube that operates as the electron source, and to realize the uniformization, it is further necessary that the surface of the cathode below the electron source be made as planar as possible.

Currently, sputtering and the photolithography that follows it have been used to obtain a cathode having a planar electrode surface. With sputtering, however, it is impossible to form a film thickness of several micrometers (μm). Sputtering, therefore, has had a problem in that since line resistance increases, large display apparatuses cannot transmit high-speed electrical signals.

A printing method such as photolithography allows the formation of a cathode with a film thickness of several micrometers. These printing methods, however, have had problems in that vertical dimensional differences between the depressions and projections on the film surface are augmented to range from 3 μm to 5 μm, and hence that the height of the carbon nanotube formed as an electron source on the surface of the cathode becomes nonuniform and the density of an emission point decreases.

The present invention has been therefore made for solving the foregoing problems associated with the conventional techniques, and an object of the invention is to provide a self-luminous flat-panel display apparatus using an electron source formed of: a carbon nanotube or any other appropriate nanomaterial that reduces wiring resistance, even in large display apparatuses with screen sizes of about 40 inches or more, is sufficiently high in electrical response characteristics, and can generate uniform light-emission patterns.

In order to attain the above object, a self-luminous flat-panel display apparatus according to the present invention suppresses any vertical dimensional differences between surface depressions and projections of a cathode in pixels formed in central and peripheral sections of a display region, to 1 μm or less. Also, an electron source layer-made of a nanomaterial is formed on the surface of the cathode, and the cathode itself is fabricated using a printing method. Thus, it becomes possible to realize a film thickness of several micrometers, reduce wiring resistance, and ensure high-speed response characteristics, and hence to solve the problems described in “BACKGROUND OF THE INVENTION.”

In another self-luminous flat-panel display apparatus according to the present invention can, preferably under such a configuration as described above, not only a shape and average particle size of the metallic particles contained in the printing paste used to form a cathode, but also a composition of the printing paste are optimized to suppress any vertical dimensional differences between surface depressions and projections of the cathode to 0.5 μm or less and realize uniform emission of light. The problems described in “BACKGROUND OF THE INVENTION” can thus be solved.

Accordingly, a self-luminous flat-panel display apparatus can be easily manufactured using a coating process, such as a screen-printing process, that is expected to achieve cost reduction.

The present invention is not limited to the above configurations or to the configurations set forth in connection with the embodiments described later herein, and it goes without saying that various changes and modifications can be conducted without departing from technical concepts of the invention.

### BRIEF DESCRIPTION OF THE DRAWINGS

FIG. 1 is an essential section development perspective view looking at a self-luminous flat-panel display apparatus of a first embodiment from an oblique upward direction;

FIG. 2 is an essential section development perspective view of the self-luminous flat-panel display apparatus of the first embodiment,-as viewed from an oblique downward direction;

FIG. 3 is an essential section plan view schematically illustrating an example of a rear panel configuration in the first embodiment;

FIG. 4 is an essential section plan view schematically illustrating an example of a front panel configuration in the first embodiment;

FIGS. 5A and 5B are essential section plan views schematically illustrating another example of a rear panel configuration in the first embodiment;

FIGS. 6A and 6B are essential section plan views schematically illustrating another example of a front panel configuration in the first embodiment;

FIG. 7 is an explanatory diagram of fabrication process steps relating to a first structural example of a rear panel in a self-luminous flat-panel display apparatus according to the present invention;

FIG. 8 is an explanatory diagram that follows FIG. 7 of the fabrication process steps for the first structural example of the rear panel in the self-luminous flat-panel display apparatus according to the present invention;

FIG. 9 is an explanatory diagram that follows FIG. 8 of the fabrication process steps for the first structural example of the rear panel in the self-luminous flat-panel display apparatus according to the present invention;

FIG. 10 is an explanatory diagram that follows FIG. 9 of the fabrication process steps for the first structural example of the rear panel in the self-luminous flat-panel display apparatus according to the present invention;

FIG. 11 is an explanatory diagram of fabrication process steps relating to a second structural example of a rear panel in a self-luminous flat-panel display apparatus according to the present invention;

FIG. 12 is an explanatory diagram that follows FIG. 11 of the fabrication process steps for the second structural example of the rear panel in the self-luminous flat-panel display apparatus according to the present invention;

FIG. 13 is an explanatory diagram that follows FIG. 12 of the fabrication process steps for the second structural example of the rear panel in the self-luminous flat-panel display apparatus according to the present invention;

FIG. 14 is an explanatory diagram that follows FIG. 13 of the fabrication process steps for the second structural example of the rear panel in the self-luminous flat-panel display apparatus according to the present invention;

FIG. 15 is a partial cutaway perspective view illustrating a total structural example of a self-luminous flat-panel display apparatus according to the present invention;

FIG. 16 is a cross-sectional view taken along line A-A′ in FIG. 15;

FIG. 17 is an explanatory diagram outlining a self-luminous flat-panel display apparatus according to the present invention;

FIG. 18 is a diagram that shows measuring points of surface roughness of a cathode, in an effective display region of a display apparatus;

FIG. 19 is an essential section enlarged cross-sectional view showing a structural example of an electron source unit to outline a self-luminous flat-panel display apparatus according to the present invention;

FIG. 20 shows another structural example of an electron source unit to outline a self-luminous flat-panel display apparatus according to the present invention; and

FIG. 21 is a definition of Rz, based on a Japanese Industrial Standard.

### DETAILED DESCRIPTION OF THE PREFERRED EMBODIMENTS

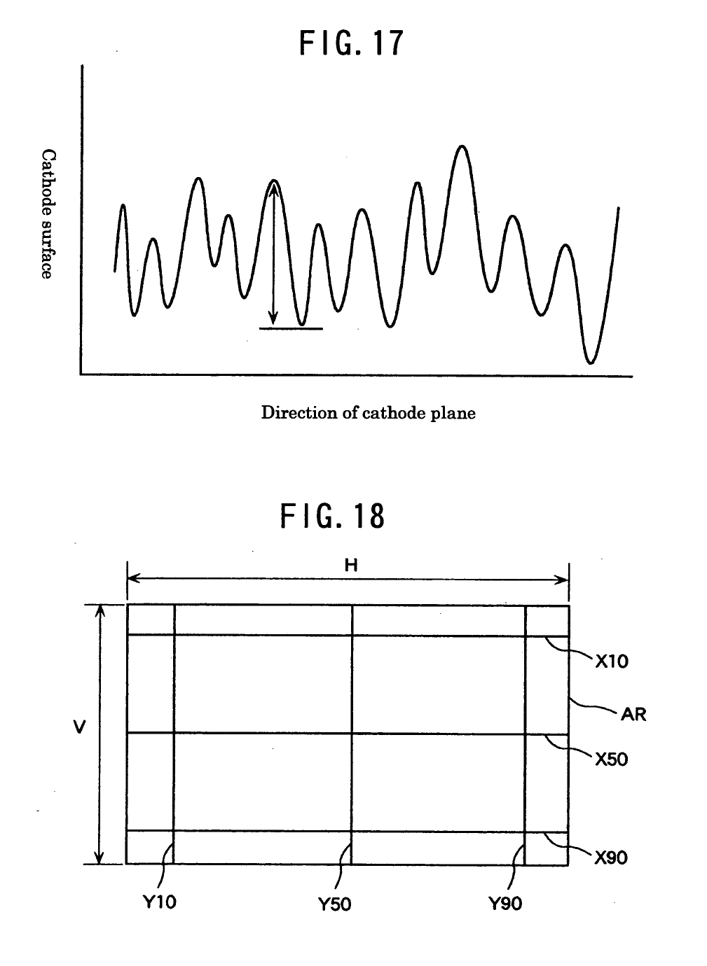

Preferred embodiments of the present invention will be described in detail hereunder with reference to the accompanying drawings. First, the present invention will be outlined using FIGS. 17 and 18.

First, a definition of surface roughness is described using FIG. 17. FIG. 17 shows an example in which surface roughness of a cathode was measured along a certain straight line using a probe method, an optical method, an electron microscope, or the like. A vertical axis denotes positions parallel to the cathode plane, and a vertical axis denotes changes in film thickness of the cathode. The film thickness has its local maximum point and its local minimum point appearing in an alternate fashion in the arrow-indicated direction in FIG. 17. A height difference between the adjacent local maximum point and local minimum point is defined as surface roughness.

In a self-luminous flat-panel display apparatus using, for example, a carbon nanotube as a nanotube material for its electron source, if local depressions and projections are present on the surface of the electron source, uniform emission of light is impeded since an electric field concentrates only on the projections. Gentle depressions and projections in a wide range, however, do not impede uniform emission of light. For these reasons, the above definition of surface roughness is considered to be appropriate.

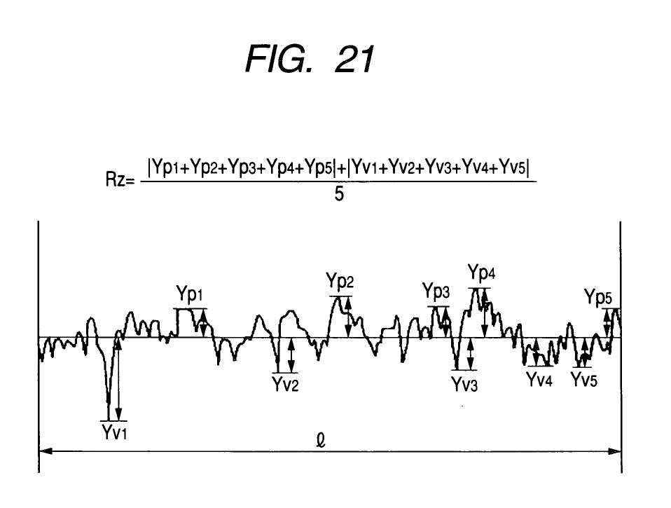

Process management based on the definition of the surface roughness shown in FIG. 17, however, may be difficult. If the Rz value provided for in-Japanese Industrial Standard (JIS) B0601 is used as another definition of surface roughness, influence by presence of singular points can be relieved and stable measurements and management can be made. This definition of Rz is shown in FIG. 21. The Rz value is a sum of the averages obtained by sampling only a reference length of section from a roughness curve in a direction of its average line and then averaging, from this average line of the sampled section, absolute values of an altitude (Yp) from a higher peak to the fifth peak and of an altitude (Yv) from the bottom of a lower valley to the bottom of the fifth valley. Stable electron emission can be achieved by reducing Rz to a value equal to or less than 1 μm, and further preferably, to a value equal to or less than 0.51 μm.

To realize a planar cathode surface using a printing method, it is necessary to optimize not only a shape and average particle size of the metallic particles contained in the printing paste used, but also a composition of the printing paste. The metallic particles are desirably of a granular form, not a flake form. In addition, it is preferable that their average particle size should range from about 0.1 to 1.0 μm and that their particle size distribution be as narrow as possible. Furthermore, viscosity and other characteristics of the paste need to be appropriately adjusted so that printing is possible in a film thickness range from about 3 to 10 μm and so that fine-structured patterns can be printed without traces of a mesh left thereon.

FIG. 18 is a diagram that shows measuring points of surface roughness of a cathode in an effective display region of a display apparatus. An effective display region AR in FIG. 18 is of an approximately rectangular plane shape and has a horizontal size H, a vertical size V, and a diagonal size D. Horizontal splitting lines for, as shown, splitting the vertical size V at positions equivalent to 10%, 50%, and 90% thereof from an upper end of the display region AR, are taken as X₁₀, X₅₀, and X₉₀, respectively. Vertical splitting lines for, as shown, splitting the horizontal size H at positions equivalent to 10%, 50%, and 90% thereof from a left end of the display region AR, are taken as Y₁₀, Y₅₀, and Y₉₀, respectively. Pixels formed in neighborhood of nine crossing points (each between the horizontal splitting line X₁₀, X₅₀, or X₉₀, and the vertical splitting line Y₁₀, Y₅₀, or Y₉₀) are the above-mentioned measuring points of surface roughness. In the present invention, vertical dimensional differences between surface depressions and projections of the cathode, at each of the above crossing points, are about 1 μm or less, and further preferably, about 0.5 μm or less.

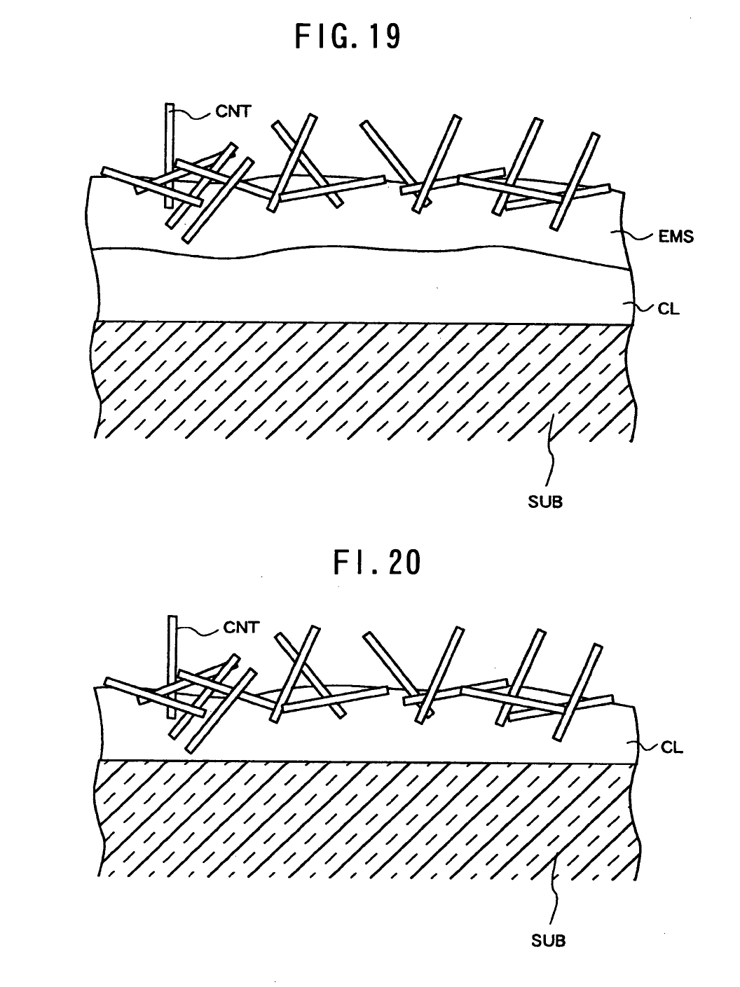

Next, embodiments of the present invention are outlined using the essential section enlarged cross-sectional views shown in FIGS. 19 and 20. FIG. 19 shows a structure in which a cathode CL with a planar surface is formed on a glass substrate SUB and an electron source layer EMS is formed on the cathode CL. Screen-printing a paste that contains, for example, a carbon nanotube CNT as a nanomaterial, forms the electron source layer EMS.

The electron source layer EMS is mechanically or optically surface-treated to raise a nap on the carbon nanotube. An electron source with uniform light-emitting characteristics can thus be formed.

FIG. 20 shows a structure in which a carbon nanotube CNT is disposed in a nap-raised condition on a planar surface of a cathode CL. This structure can be achieved by, as shown in FIG. 19, forming an electron source layer EMS on the cathode CL and peeling off the electron source layer EMS from an interface between both.

Arranging nap-raised carbon nanotubes (CNTs) on a planar surface in this way applies an electric field to each of the carbon nanotubes almost uniformly in a concentrated condition, whereby an electron source with in-plane uniform electron-irradiating characteristics can be realized.

First Preferred Embodiment

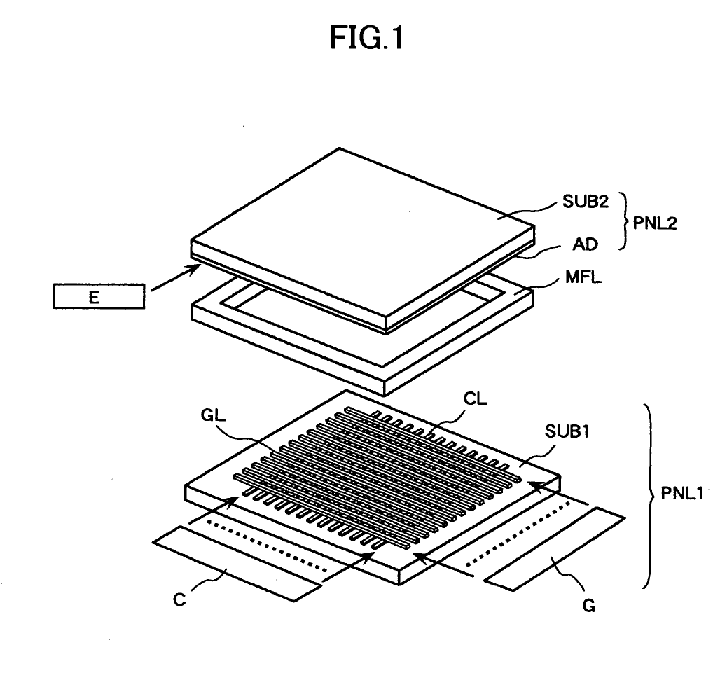

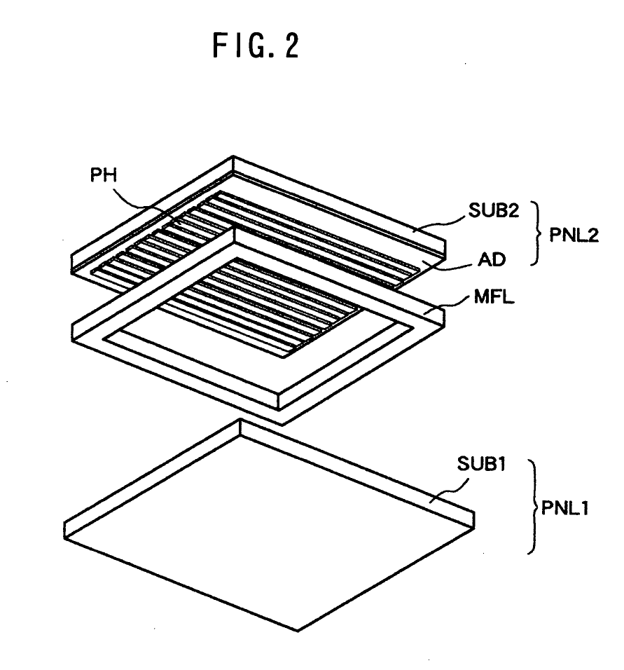

FIGS. 1 and 2 are schematic views illustrating structurally a first embodiment of a self-luminous flat-panel panel display apparatus according to the present invention, FIG. 1 being an essential section development perspective view of the self-luminous flat-panel display apparatus as viewed from an oblique upward direction, and FIG. 2 being an essential section development perspective view of the self-luminous flat-panel display apparatus as viewed from an oblique downward direction. A rear substrate SUB 1 that forms a rear panel PNL 1, and a front substrate SUB 2 that forms a front panel PNL 2 are adhesively attached to each other via a sealing frame MFL, thereby to constitute the self-luminous flat-panel display apparatus.

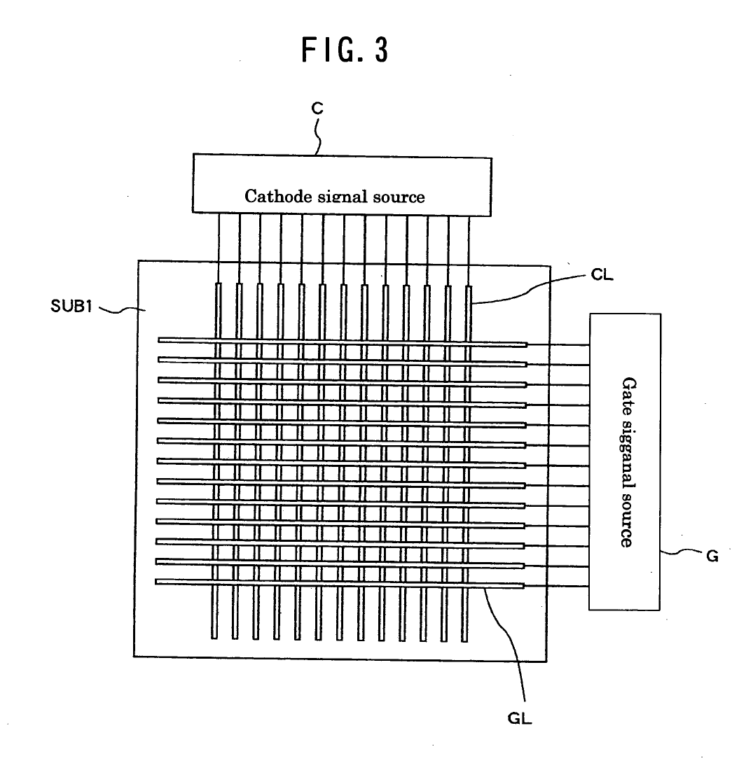

FIG. 3 is an essential section plan view looking at an inner surface of the rear substrate SUB 1 of the self-luminous flat-panel display apparatus from an upward direction. In FIG. 3, a large number of cathodes CL extending in one (first) direction and arrayed next to one another in another (second) direction intersecting with the first direction, and a large number of gate electrodes GL extending in the second direction and arrayed next to one another in the first direction are formed on the inner surface of the rear substrate SUB 1. Each cathode CL and each gate electrode GL intersect with one another via an electrical insulating layer not shown, and an electron source using, for example, a carbon nanotube as a nanomaterial, is formed at each intersecting portion.

The cathodes CL that supply electrons to the electron sources are split into a plurality of sets, and the cathodes in each set are electrically connected to a cathode bus line. Also, the gate electrodes GL are split into a plurality of sets, and the gate electrodes in each set are electrically connected to a gate electrode bus line. Selecting a portion of the cathode bus line and a portion of the gate electrode bus line forms an electron beam. group emitted as electrons from the electron source disposed at that associated position.

A cathode signal (image signal) is supplied from a cathode signal source (image signal source) to each cathode CL formed on the rear substrate SUB 1, and a gate signal (scanning signal) is applied from a gate signal source (scanning signal source) to each gate electrode GL. Electron beams are emitted from the electron source of the cathode CL intersecting with the gate electrode GL that has been selected by the gate signal.

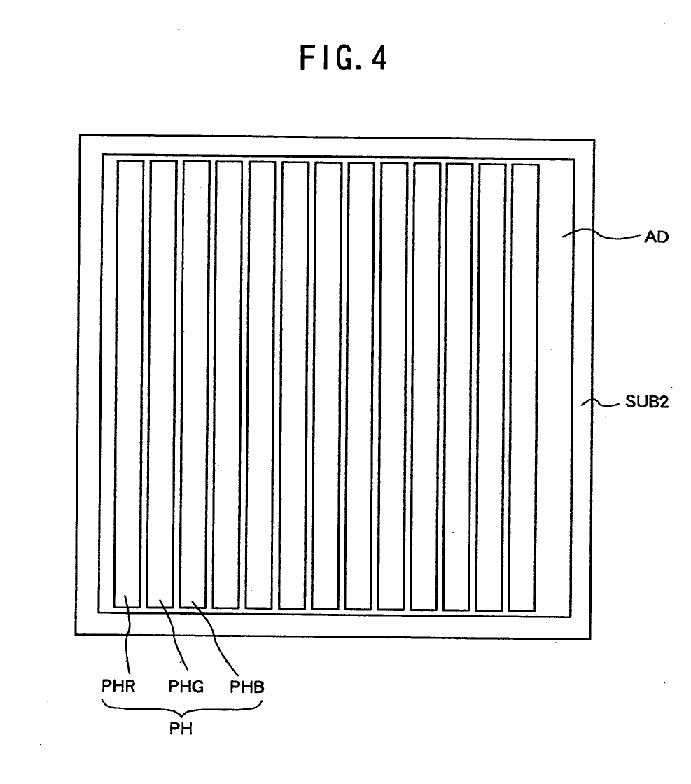

FIG. 4 is an essential section plan view looking at an inner surface of the front substrate SUB 2 of the self-luminous flat-panel display apparatus from an upward direction. In FIG. 4, phosphor layers PH are formed in a display region of the inner surface of the front substrate SUB 2, and the phosphor layers consist of a plurality of red phosphor layers PHR, green phosphor layers PHG, and blue phosphor layers PHB arrayed in a stripe format at associated locations of the electron sources located on the rear substrate SUB 1 of FIG. 3. The phosphor layers PH may be arrayed in a dot format. Also, the multicolored phosphor layers PHR, PHG, and PHB are partitioned with respect to one another by black matrix films not shown, and the phosphor layers PH and the black matrix films each have a metal-backed film on an entire rear face.

Additionally, as shown in FIG. 4, an anode AD is formed below each of the phosphor layers PH on the inner surface of the front substrate SUB 2. That is to say, each phosphor layer is formed in sandwiched format between electroconductive films in the present embodiment. The electroconductive films may be formed as anodes, only on the inner surface of the front substrate SUB 2 or may be formed as anodes, only above the phosphor layer PH. The anode AD is impressed with a required anode voltage from the high-voltage source E shown in FIG. 1. The electrons that have been emitted from the electron source of a cathode CL are accelerated by the high voltage applied to the anode AD, then impinge on a required phosphor layer PH, and cause emission of light in a required color. The emission of light from the particular phosphor layer PH is controlled in the entire display region of the front substrate SUB 2, thereby to display a two-dimensional image.

For a flat-panel display apparatus of a large screen size, a plurality of separators (spacers) constructed of a thin glass sheet or the like are set up at required intervals inside the sealing frame MFL in order to maintain a required clearance between each electron source on the rear substrate SUB 1 and each phosphor layer PH on the front substrate SUB 2.

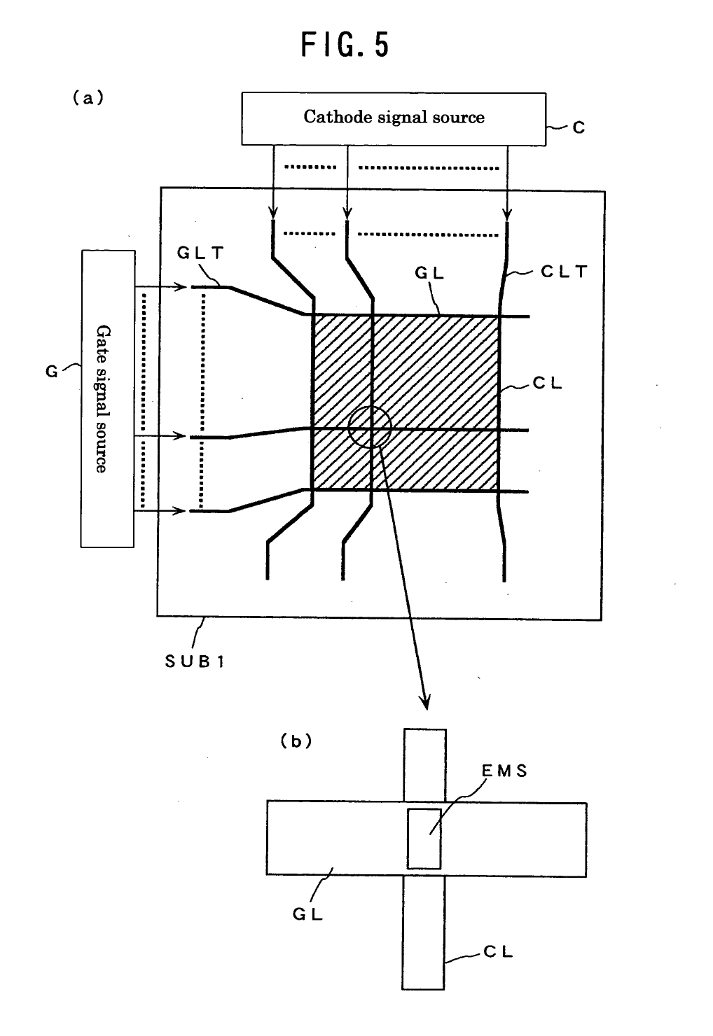

FIGS. 5A and 5B are essential section plan views schematically illustrating another example of a rear panel configuration in the first embodiment, FIG. 5A being a total configuration diagram and FIG. 5B being an essential section enlarged view of FIG. 5A. On an inner surface of the rear substrate SUB 1 constituting the rear panel of FIGS. 5A and 5B, a plurality of cathodes CL are formed in a vertical direction on the drawings, and a large number of gate electrodes GL in a horizontal direction on the drawings. Although this is not shown, the cathodes CL and the gate electrodes GL intersect with one another via electrical insulating layers, and an electron source unit EMS containing the aforementioned carbon nanotube is formed at each intersecting portion.

As described above, the electron source unit EMS containing the carbon nanotube is formed inside the gate electrode GL and inside the cathode CL exposed to the bottom of a hole extending through an electrical insulating layer (not shown) below the gate electrode GL. Each electron source unit EMS is associated with the subpixels that constitute one pixel for color display. One end of the cathode CL functions as a cathode outgoing line CLT, to which a cathode signal (image signal) is supplied from a cathode signal source C. Also, one end of the gate electrode GL functions as a gate electrode outgoing line GLT, to which a gate signal (scanning signal) is supplied from a gate signal source G.

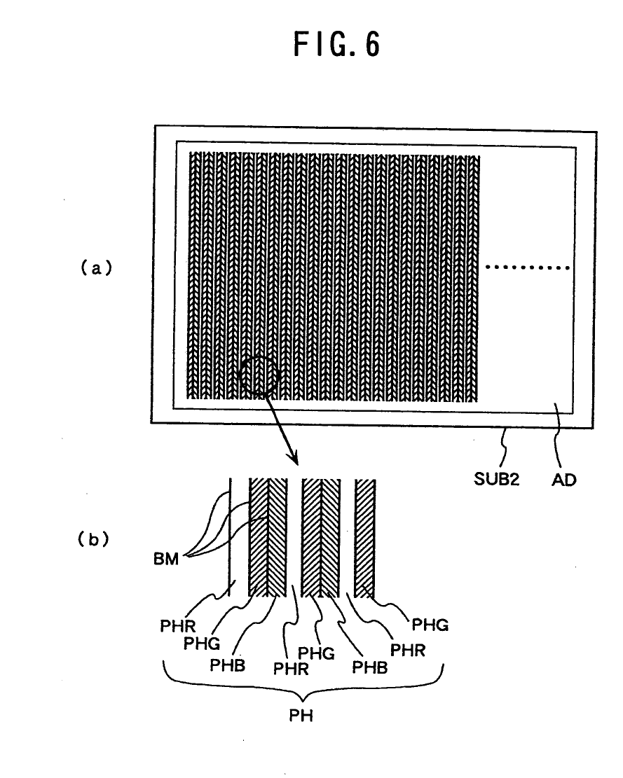

FIGS. 6A and 6B are essential section plan views schematically illustrating another example of a front panel configuration in the first embodiment, FIG. 6A being a total configuration diagram and FIG. 6B being an essential section enlarged view of FIG. 6A. In this front panel configuration, striped red (R), green (G), and blue (B) phosphor layers PHR, PHG, and PHB are partitioned with respect to one another by light-shielding layers (black matrixes) BM on an inner surface of a front substrate SUB 2. The phosphor layers PHR, PHG, and PHB constitute one phosphor layer PH. Constructing a plurality of phosphor layers PH forms a phosphor screen, on which an anode AD is formed with a film thickness from several tens of nanometers (nm) to several hundreds of nanometers (nm).

This phosphor screen is formed in the sequence described below. First, coating with a slurry consisting of a light-absorbing substance and a photosensitive resin, mask exposure to light, and an existing lift-off method that uses a hydrogen peroxide solution or the like, are employed to form striped black matrixes BM centrally between electron source units EMS at horizontal pitches of the electron source unit EMS in FIG. 5. Next, the slurry method is used to form an iterative pattern of striped red (R), green (G), and blue (B) phosphor layers PHR, PHG, PHB, respectively, and then to form phosphor layers PH with the black matrixes positioned on both sides of each phosphor layer PHR, PHG, PHB. In addition, after the formation of each striped phosphor layer PHR, PHG, PHB, an anode AD is formed by, although not shown, depositing aluminum over the entire surface of the anode to a film thickness from several tens of nanometers (nm) to several hundreds of nanometers (nm).

The thus-fabricated front panel is overlapped on the above-described rear panel via a sealing frame MFL. Next after the electron sources and the phosphors have been position-matched, the inside formed up of the front panel, the sealing frame, and the rear panel, is vacuum-evacuated for sealing, then a display panel is fabricated, and a driving circuit and other components are added to complete the self-luminous flat-panel display apparatus. Frit glass is used to seal the front panel, the sealing frame, and the rear panel together. During this sealing process, surfaces to be sealed are each coated with the frit glass by printing or dispenser coating and then fusion-bonded using the frit glass heated to about 450° C. Vacuum evacuation of respective internal spaces of the front panel, sealing frame, and rear panel that have been sealed together, is accomplished by evacuating the front panel, the sealing frame, and the rear panel from an exhaust tube connected to either thereof (usually, an appropriate place outside the display region of the rear panel, within the sealing frame). After a required vacuum pressure is reached, the exhaust pipe itself is immediately sealed to form the display panel.

Applying a cathode signal and a gate signal to the cathode CL and the gate electrode GL, respectively, of the thus-fabricated display panel, and further applying a high-voltage accelerating electrode signal from an accelerating electrode AD to the cathode CL made it possible to display a desired high-quality image.

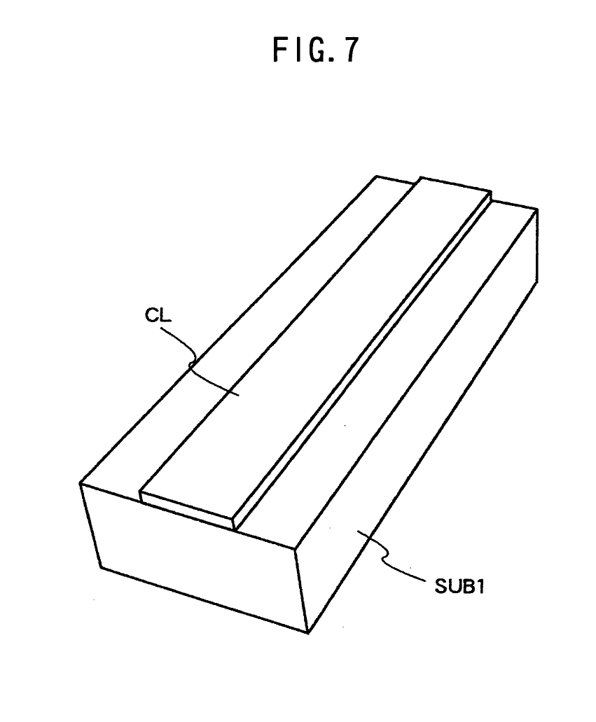

Next, a structural example of an electron source in the self-luminous flat-panel display apparatus according to the present invention, and fabrication process steps for implementing this structural example will be described using the essential section enlarged perspective views shown in FIGS. 7 to 10. Subpixels of an electron source array are shown in detail in these figures.

First, as shown in FIG. 7, the surface of a rear substrate SUB 1 using a glass sheet as its preferred material, is coated with an electrode-forming silver paste created from ethyl cellulose which contains silver fine particles and lead glass particles. This coating process is performed in stripe form by means of screen-printing, and after the coating process, the surface is baked to form a cathode CL. The electrode-forming silver paste consists of silver fine particles with an average particle size of about 0.5 μm and a weight ratio of about 80 wt %, lead glass particles with an average particle size of about 0.5 μm and a weight ratio of about 10 wt %, and ethyl cellulose with. a weight ratio of about 10 wt %. Vertical dimensional differences between depressions and projections on the surface of the cathode CL were able to be suppressed to a value equal to or less than about 0.5 μm using the above silver paste. Also, the cathode CL is about 30 μm wide and a clearance thereof with respect to an adjacent stripe-form cathode not shown is about 240 μm.

The cathode CL is composed of a mixture of silver fine particles and lead glass particles, both having an average particle size of about 0.5 μm. The ethyl cellulose is lost during baking and the lead glass particles are dissolved. The cathode CL has a film thickness of about 5 μm after baking. Three sets of 1280 such stripe-structured cathodes CL are formed to obtain 3840 pieces in all.

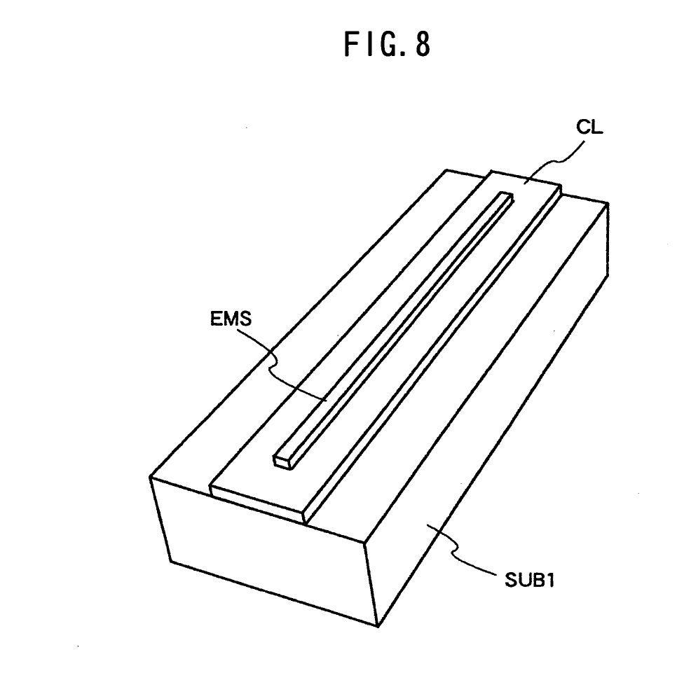

Next, as shown in FIG. 8, a silver paste is applied to the surface of the cathode CL by screen-printing to form an electron source layer EMS. This silver paste is made from ethyl cellulose which contains a multiwall carbon nanotube of about 5 nm in average diameter and also contains silver fine particles of about 1 μm in particle size to support the multiwall carbon nanotube. For better electrical contact between the multiwall carbon nanotube and the cathode CL, the silver paste can also contain other metallic fine particles such as gold ones. In addition, a double-wall carbon nanotube with an average diameter of about 2 nm may be used instead of the multiwall carbon nanotube of about 5 nm in average diameter.

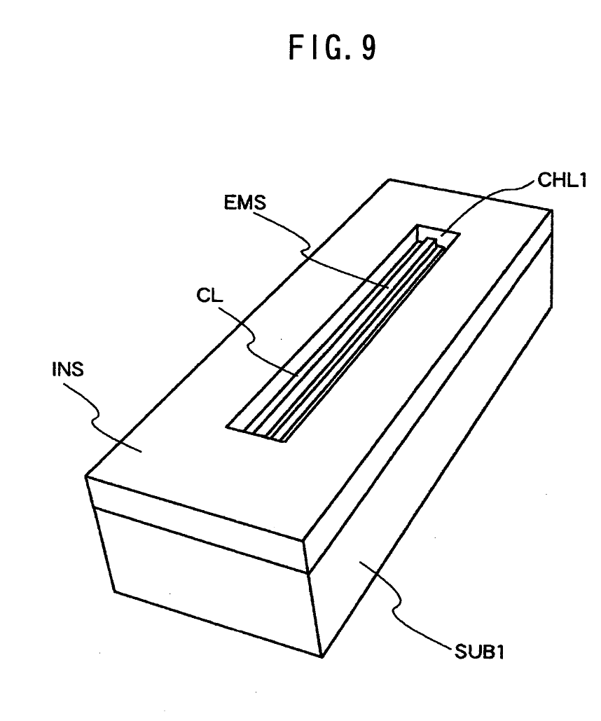

Next, as shown in FIG. 9, the surface of the rear substrate SUB 1 on which the cathode CL and the electron source layer EMS are formed is coated with frit glass by screen-printing and then baked to form an electrical insulating layer INS. The insulating layer INS has an electron source hole CHL 1 formed above a portion associated with the electron source layer EMS of the above-mentioned cathode CL. The insulating layer INS has a film thickness of about 5 μm after baking. Constructing the rear panel in this manner forms a structure in which the cathode CL and the electron source layer EMS formed thereon are partially exposed inside the electron source hole CHL 1.

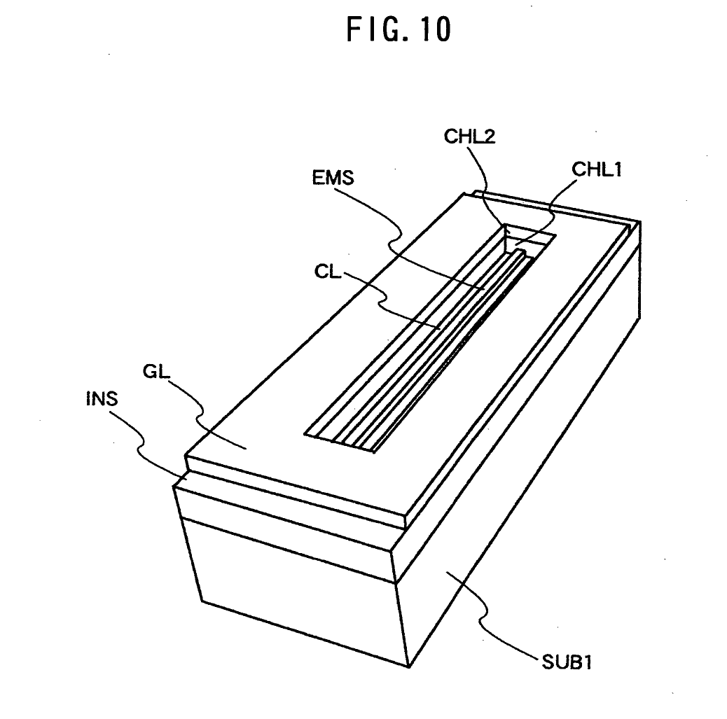

Next, as shown in FIG. 10, an electrode-forming silver paste made from ethyl cellulose which contains silver fine particles is applied to the surface of the insulating layer INS by screen-printing and then baked to form a gate electrode GL. In the insulating layer INS, an upper electron source hole CHL 2 communicating with the above-mentioned electron source hole CHL 1 is formed above a portion associated with the above-mentioned electron source layer EMS. The gate electrode GL is constructed of silver fine particles whose average particle size is about 1 μm, and has a film thickness of about 5 μm after baking. Seven-hundred and twenty such gate electrodes GL are formed.

Finally, the electron source layer EMS partially exposed inside the electron source hole CHL 2 is surface-treated to raise a nap on the carbon nanotube. The surface treatment can use a technique such as lasing, plasma processing, or mechanical processing. A carbon nanotube electron source structure that allows gate operation was formable in this way. In such an electron source structure, cathodes CL, gate electrodes GL, and electron source layers EMS are formed adjacently to one another on essentially the same plane of the rear substrate SUB 1.

While the present embodiment uses silver to form the cathodes CL, the gate electrodes GL, and the electron source layers EMS, it is possible to use any other metal having necessary electrical conductivity, or to use an alloy or a metallic multilayer film. In addition, the coating method used to form the cathodes CL, the gate electrodes GL, and the electron source layers EMS, is not limited to screen-printing and can be an ink jet method, any other special printing method, chemical vapor deposition, or the like.

Second Preferred Embodiment

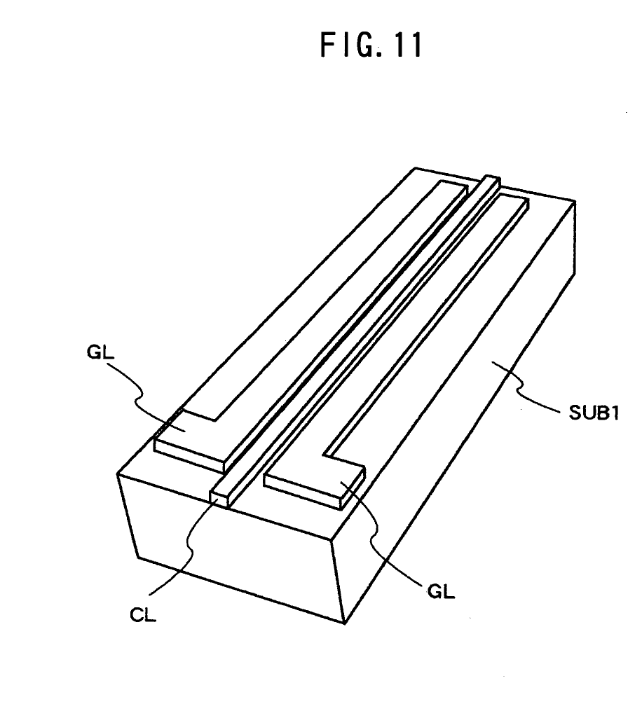

FIGS. 11 to 14 show another structural example of a rear panel in a self-luminous flat-panel display apparatus according to the present invention, and fabrication process steps for implementing this structural example. Subpixels of an electron source array are described in detail in accordance with the figures.

First, as shown in FIG. 11, the surface of a rear substrate SUB 1 using a glass sheet as its preferred material is coated with an electrode-forming silver paste created from an organic solvent which contains silver fine particles and lead glass particles. This coating process is performed in stripe form by means of screen-printing, and after the coating process, the surface is baked to form a cathode CL and gate electrodes GL at the same time. The cathode CL and the gate electrodes GL are formed on essentially the same plane of the rear substrate SUB 1. The electrode-forming silver paste consists of silver fine particles with an average particle size of about 0.5 μm and a weight ratio of about 80 wt %, borosilicate glass particles with an average particle size of about 0.5 μm and a weight ratio of about 10 wt %, and diethylene glycol monobutyl ether with a weight ratio of about 10 wt %. Vertical dimensional differences between depressions and projections on the surface of the cathode CL were able to be suppressed to a value equal to or less than about 0.5 μm using the above silver paste. The cathode CL is about 30 μm wide and a clearance thereof with respect to an adjacent stripe-form cathode is about 240 μm. Also, the cathode CL is spaced about 30 μm from the gate electrodes GL.

The cathode CL and the gate electrodes GL are each composed of a mixture of silver fine particles and borosilicate glass particles, both having an average particle size of about 0.5 μm, and the cathode CL and the gate electrodes GL each have a film thickness of about 5 μm after baking. Three sets of 1280 such stripe-structured cathodes CL are formed to obtain 3840 pieces in all.

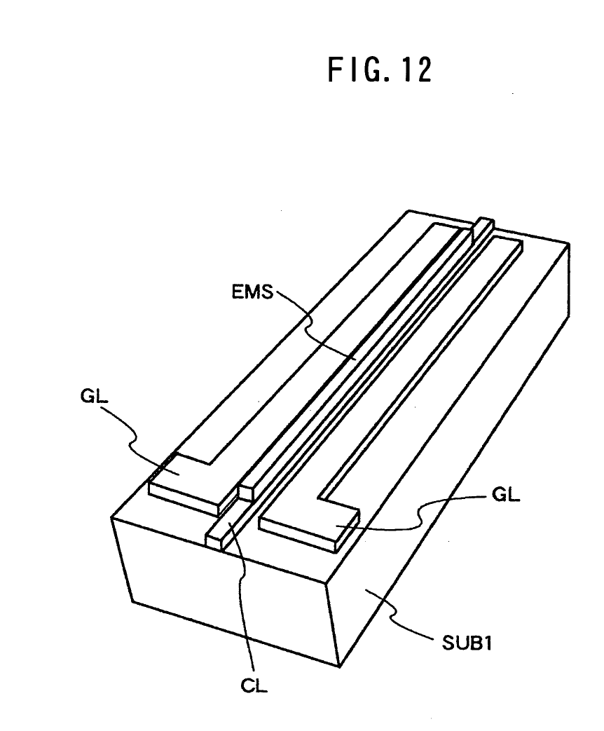

Next, as shown in FIG. 12, a silver paste is applied to the surface of the cathode CL by screen-printing to form an electron source layer EMS. This silver paste is made from ethyl cellulose which contains a multiwall carbon nanotube of about 5 nm in average diameter and also contains silver fine particles of about 0.5 μm in particle size to support the multiwall carbon nanotube. For better electrical contact between the multiwall carbon nanotube and the cathode CL, the silver paste can also contain other metallic fine particles such as gold ones. In addition, a double-wall carbon nanotube with an average diameter of about 2 nm may be used instead of the multiwall carbon nanotube of about 5 nm in average diameter.

Next, as shown in FIG. 13, the surface of the rear substrate SUB 1 on which the cathode CL and the electron source layer EMS are formed is coated with frit glass by screen-printing and then baked to form an electrical insulating layer INS. The insulating layer INS includes an electron source hole CHL formed above a portion associated with the electron source layer EMS of the above-mentioned cathode CL. The insulating layer INS also includes gate electrode contact holes CHL, each of which communicates with a corresponding one of the gate electrodes GL. The insulating layer INS has a film thickness of about 5 μm after baking. Constructing the rear panel in this manner forms a structure in which the cathode CL and the electron source layer EMS formed thereon are partially exposed inside the electron source hole CHL.

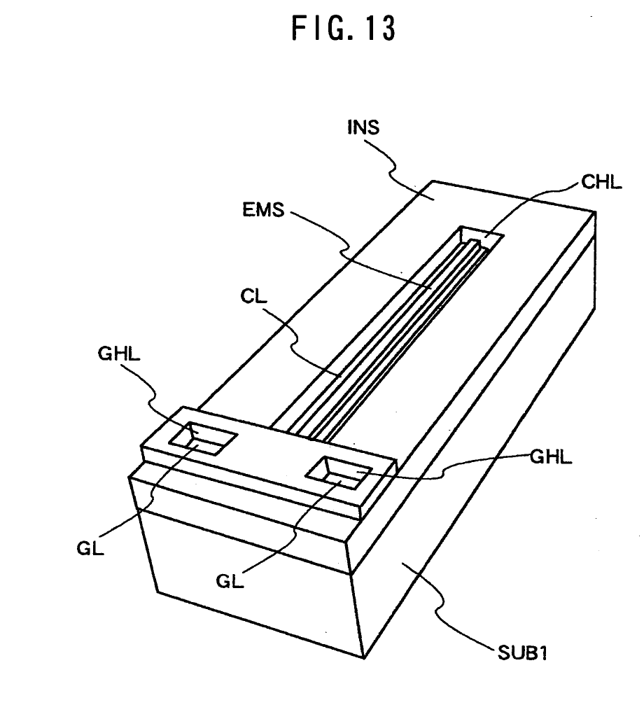

Next, as shown in FIG. 14, an electrode-forming silver paste made from an organic solvent which contains silver fine particles is applied to the sections of the insulating layer INS that are associated with the gate electrode contact holes GHL. The silver paste is applied using a screen-printing method, and then baked to form a gate electrode bus line GBL. The gate electrode bus line GBL is constructed of silver fine particles whose average particle size is about 1 μm, and has a film thickness of about 5 μm after baking. Seven-hundred and twenty such gate electrode bus lines GBL are formed.

Finally, the electron source layer EMS partially exposed inside the electron source hole CHL is surface-treated to raise a nap on the carbon nanotube. The surface treatment can use a technique such as lasing, plasma processing, or mechanical processing. A carbon nanotube electron source structure that allows gate operation is formable in this way. In such an electron source structure, cathodes CL, gate electrodes GL, and electron source layers EMS are formed adjacently to one another on essentially the same plane of the rear substrate SUB 1.

While the present embodiment uses silver to form the cathodes CL, the gate electrodes GL, and the electron source layers EMS, it is possible to use any other metal having necessary electrical conductivity, or to use an alloy or a metallic multilayer film. In addition, the silver-paste coating method used to form the cathodes CL, the gate electrodes GL, and the electron source layers EMS, is not limited to screen-printing and can be an ink jet method, any other special printing method, chemical vapor deposition, or the like.

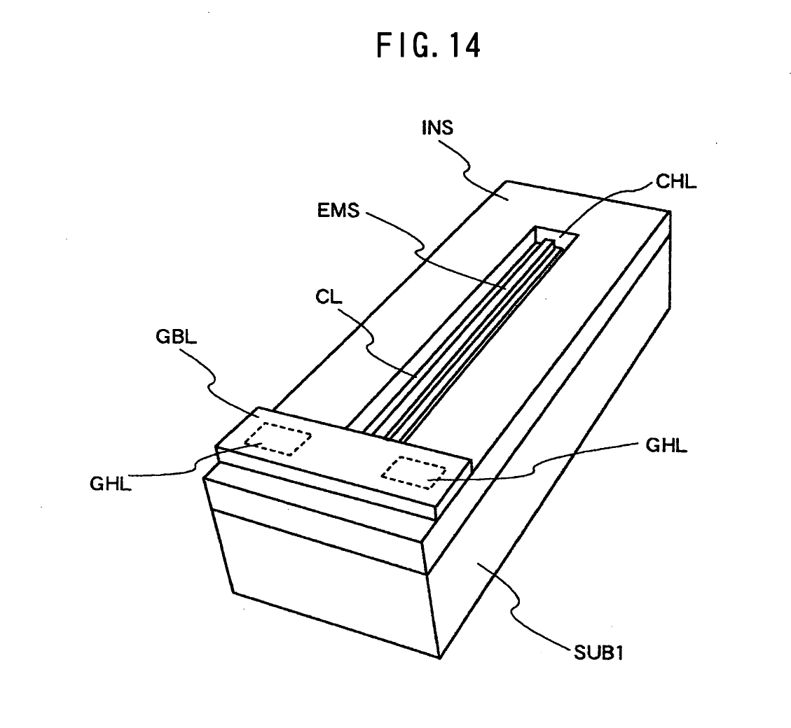

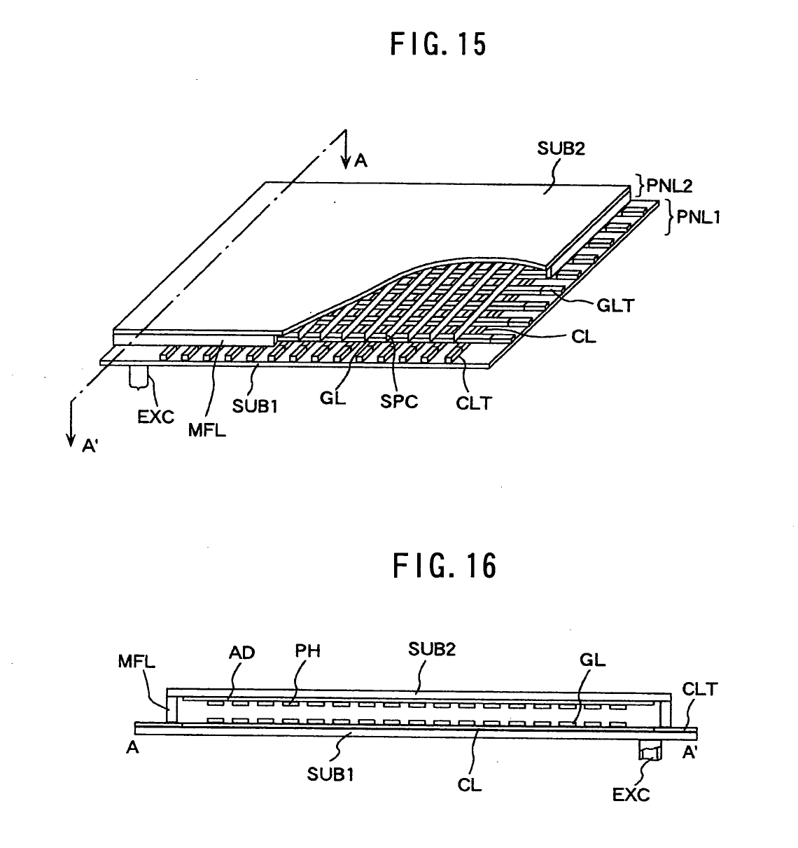

FIG. 15 is a perspective view illustrating in a partial cutaway format a total structural example of a self-luminous flat-panel display apparatus according to the present invention. Also, FIG. 16 is a cross-sectional view taken along line A-A′ in FIG. 15. A rear substrate SUB 1 that constitutes a rear panel PNL 1 has both cathodes CL and gate electrodes GL on an inner surface, and an electron source is formed at the section where each cathode CL and each gate electrode GL intersect with each other. The cathode CL has a cathode outgoing line CLT at its end, and the gate electrode GL has a gate electrode outgoing line GLT at its end.

Such anodes and phosphor layers as described earlier herein are formed on an inner surface of a front substrate SUB 2 which constitutes a front panel PNL 2. The rear substrate SUB 1 constituting the rear panel PNL 1, and the front substrate SUB 2 constituting the front panel PNL 2 are adhesively attached to each other with a sealing frame MFL interposed between their respective peripheral edges. In order to maintain a desired attaching clearance, separators SPC that use a glass sheet as their preferred material, are buried vertically between the rear substrate SUB 1 and the front substrate SUB 2. FIG. 16 is a cross-sectional view taken on line A-A′ extending in a longitudinal direction of the separators SPC. The separators SPC, therefore, are not shown in FIG. 16.

An internal space formed in a sealed condition between the rear panel PNL 1, the front panel PNL 2, and the sealing frame MFL, is maintained in a desired vacuum state by evacuation from an exhaust pipe EXC provided on a portion of the rear panel PNL 1.

According to the present invention, it is possible, by suppressing any vertical dimensional differences between depressions and projections on the entire surface of a cathode to 1 μm or less and forming on the cathode surface an electron source layer made of a nanotube material, to obtain an extremely excellent effect that a large self-luminous flat-panel display apparatus using an electron source formed from a nanotube material reduced in wiring resistance, exhibiting sufficiently high electrical response characteristics, and generating uniform light-emission patterns, can be achieved.

According to the present invention, it is also possible to obtain another extremely excellent effect in that a large self-luminous flat-panel display apparatus can be manufactured easily and at a low price using a normal printing/coating process or the like.

What is claimed is:

1. A self-luminous flat-panel display apparatus, comprising:
a rear panel including:
a large number of cathodes extending in a first direction, each of the cathodes being arrayed next to the other in a second direction intersecting with the first direction, and each cathode having a surface with an electron source thereon; and
a large number of gate electrodes extending in the second direction, each of the gate electrodes being arrayed next to the other in the first direction and being impressed with a potential-at which the quantity of electron beams emitted from the electron source is to be controlled at an intersecting portion relative to the associated cathode;
wherein the rear panel constitutes a display region with a large number of pixels formed at the intersecting portion between the cathode and the associated gate electrode; and
a front panel which includes multicolored phosphor layers each emitting light by excitation of the electron beams acquired from the electron source existing in the display region of the rear panel, and anodes;
wherein vertical dimensional differences between depressions and projections on the surface of the cathode within the pixels formed near a crossing point between a first splitting line for splitting a dimension of the display region in the first direction at respective positions equivalent to 10%, 50%, and 90% of the dimension from one end of the display region, and a second splitting line for splitting a dimension of the display region in the second direction at respective positions equivalent to 10%, 50%, and 90% of the dimension from one end of the display region, are equal to or less than 1 μm and the electron source formed on the surface of the cathode is made of a nanomaterial.

2. The self-luminous flat-panel display apparatus according to claim 1, wherein the vertical dimensional differences between the depressions and projections on the surface of the cathode are suppressed to a value equal to or less than 0.5 μm.

3. The self-luminous flat-panel display apparatus according to claim 1, wherein the cathode is fabricated using a printing method.

4. The self-luminous flat-panel display apparatus according to claim 2, wherein the cathode is fabricated using a printing method.

5. The self-luminous flat-panel display apparatus according to any one of claims 1 to 4, wherein the nanomaterial is a carbon nanotube.

6. A self-luminous flat-panel display apparatus, comprising:
a rear panel including:
a large number of cathodes extending in a first direction, each of the cathodes being arrayed next to the other in a second direction intersecting with the first direction, and each cathode having a surface with an electron source thereon; and
a large number of gate electrodes extending in the second direction, each of the gate electrodes being arrayed next to the other in the first direction and being impressed with a potential at which the quantity of electron beams emitted from the electron source is to be controlled at an intersecting portion relative to the associated cathode;
wherein the rear panel constitutes a display region with a large number of pixels formed at the intersecting portion between the cathode and the associated gate electrode; and
a front panel which includes multicolored phosphor layers each emitting light by excitation of the electron beams acquired from the electron source existing in the display region of the rear panel, and anodes;
wherein, when vertical dimensional differences between depressions and projections on the surface of the cathode within the pixels formed near a crossing point between a first splitting line for splitting a dimension of the display region in the first direction at respective positions equivalent to 10%, 50%, and 90% of the dimension from one end of the display region, and a second splitting line for splitting a dimension of the display region in the second direction at respective positions equivalent to 10%, 50%, and 90% of the dimension from one end of the display region, are evaluated in terms of Rz, a value of Rz is equal to or less than 1 μm and the electron source formed on the surface of the cathode is made of a nanomaterial.

7. The self-luminous flat-panel display apparatus according to claim 6, wherein the Rz value of the cathode surface is equal to or less than 0.5 μm.

8. The self-luminous flat-panel display apparatus according to claim 6, wherein the cathode is fabricated using a printing method.

9. The self-luminous flat-panel display apparatus according to claim 7, wherein the cathode is fabricated using a printing method.

10. The self-luminous flat-panel display apparatus according to any one of claims 6 to 9, wherein the nanomaterial is a carbon nanotube.
